(19) United States
(12) Patent Application Publication
(10) Pub. No.: US 2005/0109050 A1
(43) Pub. Date: May 26, 2005

(54) Refrigerant charge level determination

(76) Inventors: Kevin J. Laboe, Birmingham, MI (US); Paul Netkowski, Auburn, MI (US); Mark E. Dawson, Clarkston, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/766,223

(22) Filed: Jan. 28, 2004

Related U.S. Application Data
(60) Provisional application No. 60/516,948, filed on Nov. 3, 2003.

(51) Int. Cl. G01K 15/00

(52) U.S. Cl. 62/199

(57) ABSTRACT

An apparatus and method for determining a level of a refrigerant fluid in a vehicle cooling system. The apparatus measures the temperature of the refrigerant conduit at inlet and outlet sides of the system evaporator and correlates the temperature difference to pre-stored data indicative of various fluid levels.

### FIELD OF THE INVENTION

The present invention relates generally to a measurement system, and more particularly to a system that employs a method for determining the level of refrigerant fluid in an air conditioning system of a vehicle.

### BACKGROUND OF THE INVENTION

Maintaining the proper level of refrigerant fluid in an air conditioning system in a vehicle is important. The efficiency of the system suffers if the system has a low level of refrigerant fluid. In addition, units such as compressors within the system may suffer costly damage if undercharged.

A known method for determining the refrigerant charge level is by implementing a so-called two minute test, wherein the ambient temperature in a car assembly plant and the temperature of the air from a panel outlet of the vehicle are measured and recorded. The temperature from the panel outlet is measured by running the air conditioner in the vehicle at a high temperature for approximately two minutes. After two minutes, the temperature from the panel outlet is measured. The temperature difference between the ambient temperature and the temperature from the panel outlet is calculated and recorded. When the temperature difference is below a certain value, then the level of refrigerant fluid is deemed abnormally low. However, this method is not reliable in a plant with common temperatures ranging from 65 to 70 degrees. This method allows the operator to know if a gross leak occurred in the system. However, this method does not catch small leaks or minor misfills that occur in the system due to the temperatures in the plant. In addition, this method does not provide instant results.

Therefore there is a need for an improved method for determining the level of refrigerant fluid in a vehicle. In addition, there is a need for a method that instantaneously provides accurate levels of refrigerant fluid levels in a vehicle.

### SUMMARY OF THE INVENTION

An apparatus for determining a level of a refrigerant fluid in a vehicle includes a first temperature measuring device adapted to be coupled to a first region of a conduit containing the refrigerant fluid; a second temperature measuring device adapted to be coupled to a second region of the conduit; and a data processing system coupled to outputs of the first and second measuring devices and operative to determine a temperature difference between the first and second conduit regions from the outputs of the first and second temperature measuring devices and to correlate the temperature difference to the level of refrigerant fluid.

In another aspect of the invention, a method for determining a level of refrigerant fluid in a cooling system of a vehicle, comprising measuring a first temperature at a first region of a conduit containing the refrigerant; measuring a second temperature at a second region of the conduit; determining a temperature difference between the first and second means; and determining the level of refrigerant fluid by correlating the measured temperature difference with pre-selected data.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exemplary automotive air conditioning system;

FIG. 2 is a refrigerant measurement system of the present invention;

FIG. 3 is a flowchart showing the operational steps of the refrigerant measurement system of the present invention; and

FIG. 4 is an exemplary graph of temperature results according to the present invention.

### DETAILED DESCRIPTION OF THE PREFERRED EMBODIMENTS

The following description is merely exemplary in nature and is in no way intended to limit the invention, its application, or uses.

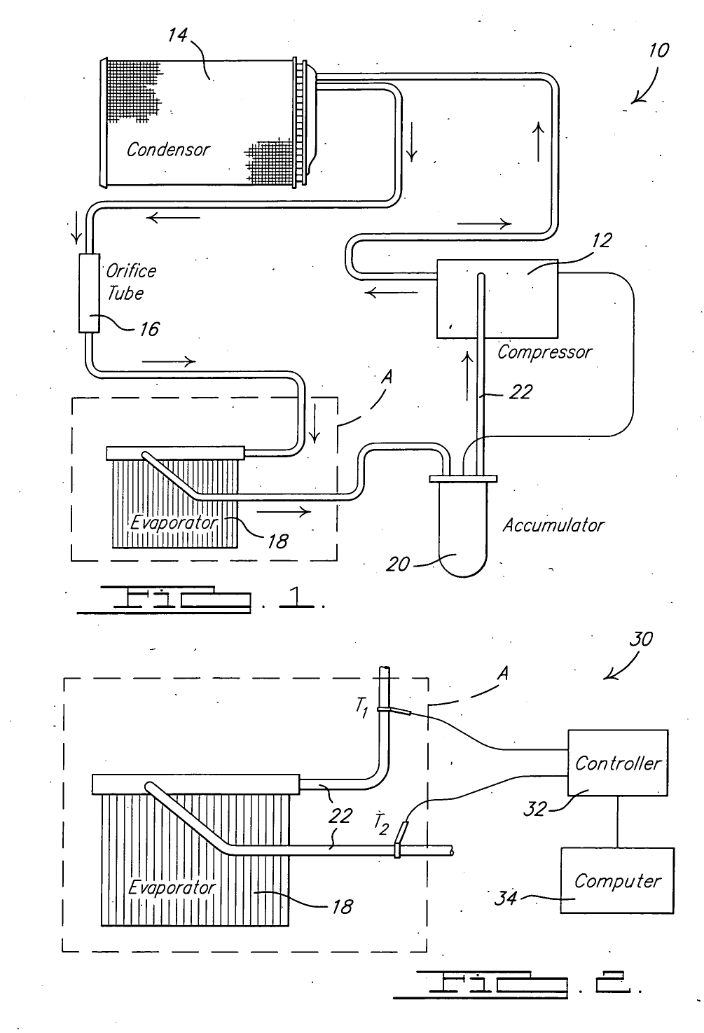

FIG. 1 is an exemplary automotive air conditioning system 10. The system 10 includes a compressor 12, a condenser 14, an orfice tube 16, an evaporator 18, an accumulator 20, and a conduit 22 containing a refrigerant fluid. Typically, the compressor 12 is coupled to the condenser 14, the condenser 14 is coupled to the orfice tube 16, the orfice tube 16 is coupled to the evaporator 18, and the evaporator 18 is coupled to the accumulator 20, which is coupled to the compressor 12. The conduit 22 is coupled to each component such that the refrigerant fluid runs through each component of the system 10, as shown with direction arrows.

Generally, the compressor 12 is a pump that includes an intake side and a discharge side. The intake side draws in a refrigerant gas from the accumulator 20. In some cases, the compressor 12 draws in a refrigerant gas directly via an outlet of the evaporator 18. Once the refrigerant gas is drawn into the intake side, it is compressed and sent to the condenser 14 as a high temperature gas. As the compressed gas is introduced into a top side of the condenser 14, the gas is cooled off. As the gas cools, it condenses and exits a bottom side of the condenser 14 as a high pressure liquid. The high pressure liquid flows through the orfice tube 16, turning the high pressure liquid into a low pressure and low temperature liquid. The low pressure and low temperature liquid then flows through an inlet of the evaporator 18, which is a heat exchanger type device, where the liquid goes through the process of heat absorption, thereby providing the cool air in the vehicle. An outlet of the evaporator 18 outputs a low pressure and low temperature gas/liquid that flows into the accumulator 20. The accumulator 20 separates the gas and the liquid, such that the liquid remains in the accumulator 20, while only the gas is sent to the compressor 12. This process is repeated continuously. Region A is typically the area in which the measuring process is performed, as will further be discussed below.

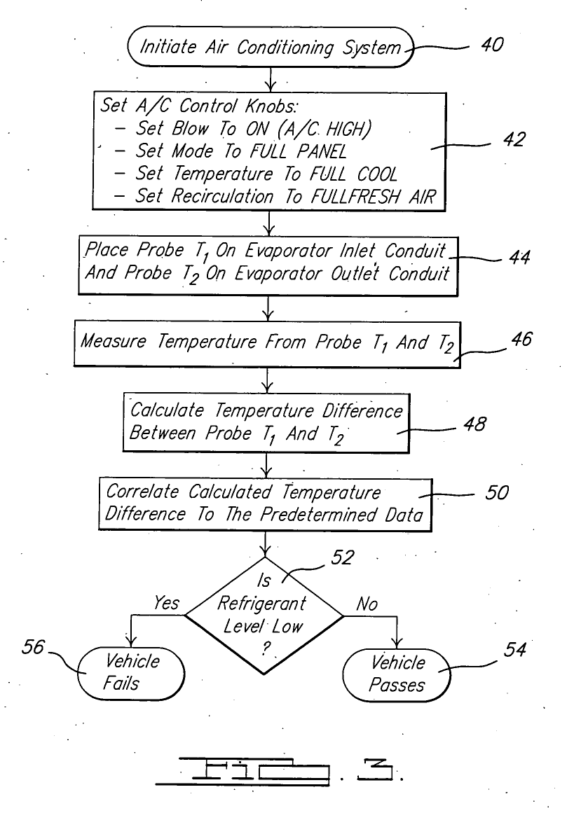

FIG. 2 illustrates a refrigerant measurement system 30 of the present invention. The measurement system 30 is used to perform measurements on region A in the air conditioning system 10. The measurement system 30 generally comprises measuring probes T1, T2, a controller 32, and a computer 34. The probes T1, T2 are coupled to an inlet and outlet portion of the conduit 22 running through evaporator 18. Specifically, the probes T1, T2 are placed above a skin of the inlet and outlet portion of the evaporator 18. In this example, T1 is coupled to a skin surface of the evaporator inlet and probe T2 is coupled to a skin surface of the evaporator outlet. The probes T1, T2 are used to measure the temperature of the skin surface of the evaporator inlet and the evaporator outlet. The temperature of the skin surface of the inlet and outlet portion of the conduit 22 running through evaporator 18 is used to infer the actual temperature of the refrigerant fluid flowing through the conduit 22. The probes T1, T2 can be any type of temperature measuring device, such as, for example, thermocouple probes. The controller 32 is coupled to probes T1, T2 for compiling the temperature measurements from the probes T1, T2 and uploading these measurements into the computer 34. The computer 34 is in communication with the controller 32 for determining the level of refrigerant fluid in the air conditioning system 10, which will further be discussed below. The controller 32 can be any type of controller used to collect data from one source and upload it to another source, such as, for example, a programmable logic controller (PLC). The computer 34 can be any type of device, well known in the art, for processing, storing, and displaying data. In another aspect, the functions of the controller 32 are performed through the computer 34. As such, the computer 34 is directly coupled to the probes T1,T2.

The computer 34 includes predetermined data for determining the level of refrigerant in the air conditioning system 10 of a vehicle. The data includes predetermined temperature values that correspond to a level of refrigerant fluid. The predetermined temperature values are values representing a number of predetermined temperature difference measurements measured between the inlet and outlet of the evaporator 18. This predetermined data is determined by placing a known amount of refrigerant fluid in a vehicle, setting the air conditioning system control knobs to blow maximum cool air, measuring the skin surface of the inlet and outlet of the evaporator 18, and recording the temperature value that represents the difference in temperatures between the inlet and outlet of the evaporator 18. In doing so, the level of refrigerant fluid can be determined because each known level of refrigerant fluid corresponds to a temperature value. The predetermined data is compiled by placing different amounts of refrigerant fluid in the system 10 and recording the temperature value for each amount. The predetermined data is uploaded into the computer 34 as part of a program for determining the level of refrigerant in a vehicle while in production.

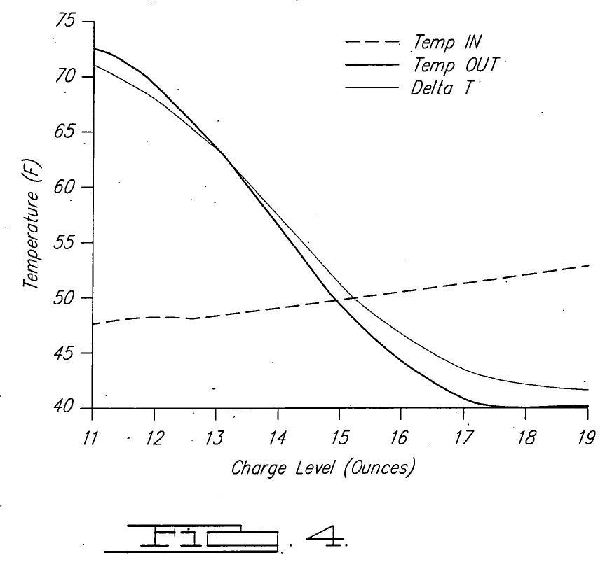

FIG. 3 is a flowchart showing the operational steps of the refrigerant measurement system 30. The system 30 starts by initializing the air conditioning system 10 in step 40. In step 42, a set of air conditioning control knobs are each set to a predetermined position, which will further be discussed below. In step 44, probe T1 is placed on the evaporator inlet conduit and probe T2 is placed on the evaporator outlet conduit. Next, the temperature from probes T1 and T2 are measured in step 46. In step 48, the temperature difference between T1 and T2 is calculated. The calculated temperature difference is correlated to the predetermined data in step 50. In decision step 52, the computer 34 determines whether or not the refrigerant fluid is too low. If the answer is no, then the vehicle passes in answer box 54. If the answer is yes, then the vehicle fails in answer box 56. When the answer is yes or no, the user can be informed in many ways. For example, an indicator green light in the production line can automatically be turned on by the computer 34 to inform the user that the vehicle has enough refrigerant fluid. Similarly, an indicator red light in the production line can automatically be turned on by the computer 34 to alert the operator that the level of refrigerant fluid in the vehicle is too low. Alternatively, the computer 34 can be used to display the level of refrigerant fluid in either a graphical or numerical manner.

FIG. 4 is an exemplary graph of temperature results according to the present invention. The graph includes the temperature values measured from the inlet and outlet conduit of the evaporator 18. The graph further includes the temperature difference calculated between the inlet and outlet temperatures, which is indicated as Delta T. In this example, when the temperature difference is below approximately 53 degrees Fahrenheit, then the level of refrigerant fluid in the system 10 is below the level considered as a full charge, which in this case is 18 ounces. When the temperature difference is above approximately 53 degrees Fahrenheit, then the level of refrigerant fluid in the system 10 is considered a full charge. In this case, when the temperature is about 54 degrees Fahrenheit, then there are approximately 19 ounces of refrigerant fluid in the system 10. It should be understood that this graph is merely an example and that the graph may vary depending on the application or type of vehicle.

Referring back to FIG. 3, the air conditioning control knobs in step 42 comprise a Blower, a Mode, a Temperature, and a Recirculation control knob. The Blower control knob is turned on high so that the air conditioning system 10 is operating at a high speed. The Mode control knob is set to full panel. As such, the air blows through the outlets located on the instrument panel of the vehicle only. The Temperature control knob is set to full cool. As such, the temperature of the air blowing from the outlets is at a low temperature to provide cool air. The Recirculation control knob is set to full fresh air. As such, only air from the outside of the vehicle is being circulated in the system 10. The control knobs are set to these particular positions to place the system 10 in a condition that allows for an accurate temperature measurement. The predetermined data is configured to take into account these positions as well as the type of air conditioning system being used. It should be understood that the types of control knobs may vary depending on the type of vehicle being tested.

In another aspect of the present invention, the system 30 further includes a bar coding system. The bar coding system includes a data sheet and a scanner. The data sheet can be placed anywhere along the vehicle, such as, for example, on the hood of the vehicle. The data sheet includes a bar code with stored information, such as the vehicle identification number (VIN). The data sheet includes information to allow the computer 34 to identify the type of vehicle being tested. The scanner is a mobile device in communication with the computer 34. The scanner is used to scan the data sheet to allow the computer 34 to retrieve information and store additional information relating to the vehicle, in this case, the level of refrigerant fluid in the vehicle.

In operation, probes T1, T2 are first placed on the inlet and outlet conduit of the evaporator 18, respectively. The operator then scans the bar code of the data sheet using the scanner. The computer 34 uploads the information regarding the vehicle being tested. Once the computer 34 identifies the vehicle, the operator measures the temperature from probes T1, T2. The controller 32 then calculates the temperature difference between the probes T1, T2 and sends the results to the computer 34. The computer 34 uses this information to calculate the level of refrigerant fluid in the vehicle. The computer 34 also stores the data in connection with the vehicle. In doing so, any information regarding the vehicle can be displayed at any time using the bar coding system.

A valuable advantage to the present invention is its ability to accurately and instantly measure the level of refrigerant fluid in a vehicle while in production. The present invention allows the operator to catch small leaks and minor misfills before being taken out of production. As such, the vehicle with a low refrigerant level can be taken out of the production line and re-evaluated. In addition, the present invention provides a method for storing the refrigerant charge level, along with any additional data regarding a vehicle, in a computer where it can be displayed at any time.

The description of the invention is merely exemplary in nature and, thus, variations that do not depart from the gist of the invention are intended to be within the scope of the invention. Such variations are not to be regarded as a departure from the spirit and scope of the invention.

1. An apparatus for determining a level of a refrigerant fluid in the cooling system of a vehicle comprising:
a first temperature measuring device adapted to be coupled to a first region of a conduit containing the refrigerant fluid;
a second temperature measuring device adapted to be coupled to a second region of the conduit; and
a data processing system coupled to outputs of the first and second measuring devices and operative to determine a temperature difference between the first and second conduit regions from the outputs of the first and second temperature measuring devices and to correlate the temperature difference to the level of refrigerant fluid.

2. The apparatus of claim 1, wherein the first temperature measuring device is adapted to be coupled to an input conduit of an evaporator of the cooling system and wherein the second temperature measuring device is adapted to be coupled to an output conduit of the evaporator of the cooling system.

3. The apparatus of claim 1, wherein the data processing system uses a table of pre-selected data that includes a plurality of temperature differences that correspond to a plurality of levels of refrigerant fluid.

4. The apparatus of claim 1, wherein the data processing system further comprises a monitor for displaying the level of refrigerant.

5. The apparatus of claim 1, wherein the first and second temperature measuring devices are thermocouple probes.

6. The apparatus of claim 1, further comprising an indicating device for informing the user when the level of refrigerant fluid in the cooling system is below a pre-selected charge level.

7. A method for determining a level of refrigerant fluid in a cooling system of a vehicle comprising:
measuring a first temperature at a first region of a conduit containing the refrigerant;
measuring a second temperature at a second region of the conduit;
determining a temperature difference between the first and second region; and
determining the level of refrigerant fluid by correlating the measured temperature difference with pre-selected data.

8. The method of claim 7, wherein the first region of the conduit is located at an inlet side of an evaporator of the cooling system and the second region of the conduit is located at an outlet side of the evaporator.

9. The method of claim 7, wherein the pre-selected data includes a plurality of temperature differences that correspond to a plurality of levels of refrigerant fluid.

10. The method of claim 7, wherein a data processing system determines the temperature difference and the level of refrigerant fluid.

11. The method of claim 10, wherein the data processing system includes a monitor for displaying the level of refrigerant.

12. The method of claim 7, further comprising informing the user when the level of refrigerant fluid in the cooling system is below a pre-selected charge level.
